(19) United States
(12) Patent Application Publication
(10) Pub. No.: US 2024/0157457 A1
(43) Pub. Date: May 16, 2024

(54) PROCESS FOR HIGH DENSITY SOLDER INTERCONNECT

(71) Applicant: Seagate Technology LLC, Fremont, CA (US)

(72) Inventors: Daniel Glen Hardy, Eden Prairie, MN (US); Aaron Michael Collins, Minneapolis, MN (US); Joseph Langford Nelson, Minneapolis, MN (US)

(21) Appl. No.: 18/505,287

(22) Filed: Nov. 9, 2023

Related U.S. Application Data
(60) Provisional application No. 63/424,228, filed on Nov. 10, 2022.

(51) Int. Cl. B23K 1/00; B23K 1/005

(52) U.S. Cl. CPC B23K 1/0016; B23K 1/0056

(57) ABSTRACT

A method of interconnecting multiple components of an electrical assembly with a solder joint that includes the steps of positioning a suspension adjacent to a slider to provide a connection area between the suspension and the slider, wherein the suspension comprises a pre-deposited quantity of solder material with a height that provides for a predefined gap between a lower surface of the slider and an upper surface of the solder material, and applying energy to the solder material to melt the solder material and allow it to move toward and contact the lower surface of the slider.

### CROSS-REFERENCE TO RELATED APPLICATIONS

This application claims the benefit of U.S. Provisional Patent Application having Ser. No. 63/424,228 titled “PROCESS FOR HIGH DENSITY SOLDER INTERCONNECT” filed Nov. 10, 2022, the entire contents of which are incorporated herein by reference for all purposes herein.

### BACKGROUND

Hard disc drive (HDD) systems typically include one or more data storage discs with concentric tracks containing information. A transducing head carried by a slider is used to read from and write to a data track on a disc, wherein each slider has an air bearing surface that is supportable by a cushion of air generated by one of the rotating discs. The slider is carried by an arm assembly that includes an actuator arm and a suspension assembly, which can include a separate gimbal structure or can integrally form a gimbal.

As the density of data desired to be stored on discs continues to increase, more precise positioning of the transducing head and other components is becoming increasingly important. In many conventional systems, head positioning is accomplished by operating the actuator arm with a large-scale actuation motor, such as a voice coil motor, to position a head on a flexure at the end of the actuator arm. A high-resolution head positioning mechanism, or microactuator, is advantageous to accommodate the high data density.

The manufacturing of components of HDD systems often includes providing an electrical connection via solder material between sliders and suspension assemblies, either of which may include bonding pads. This solder material is often supplied to a component via solder jetting, which can have at least some inherent trajectory error and possible solder ball deformation upon impact with a surface to which it is applied that can lead to unintentional solder contact with adjacent bond pads or solder interconnects. This can then lead to bridging or open connections, particularly in high-density applications. Thus, there is a desire to provide additional solder placement techniques that allow for accurate solder connections in high density applications.

### SUMMARY

Aspects of the invention described herein are directed to the processing of solder materials to provide for accurate attachment of sliders to their associated head gimbal assemblies in hard disc drives. Such methods and configurations are particularly beneficial with the continuing desire to decrease the size of electronic components in the data storage industry.

Aspects of the invention described herein are directed to a method of interconnecting multiple components of an electrical assembly with a solder joint. The method comprises the steps of positioning a suspension adjacent to a slider to provide a connection area between the suspension and the slider, wherein the suspension comprises a pre-deposited quantity of solder material with a height that provides for a predefined gap between a lower surface of the slider and an upper surface of the solder material, and applying energy to the solder material to melt the solder material and allow it to move toward and contact the lower surface of the slider. The method may further include a step of continuing to heat the solder during its contact with the lower surface of the slider to create a solder joint between the suspension and the slider.

With aspects described herein, the lower surface of the slider may include a slider bond pad such that the solder joint is formed between the suspension and the slider bond pad. The lower surface of the slider and an upper surface of the suspension may be generally parallel. Further, the predefined gap may be provided by stand-offs at the interface between the slider and the suspension. The step of applying energy may include applying laser radiation to the solder material, and the pre-deposited quantity of solder material may be positioned on an upper surface of the suspension. The upper surface of the suspension may further include a trace material. The upper surface of the suspension may further include a non-wettable portion.

In an aspect of the invention, a front surface of the slider that is generally perpendicular to the lower surface of the slider may comprise a slider bond pad such that the solder joint is formed between the suspension and the slider bond pad.

The lower surface of the slider may also include a pre-deposited quantity of slider solder material, wherein the method may further include a step of applying energy to the slider solder material to melt the slider solder material and allow it to move toward and contact the solder material of the suspension.

Another aspect of the invention is directed to a method of interconnecting multiple components of an electrical assembly with a solder joint that includes the steps of: positioning a suspension adjacent to a slider to provide a connection area between the suspension and the slider, wherein a lower surface of the slider comprises a pre-deposited quantity of solder material with a height that provides for a predefined gap between a lower surface of the solder material and an upper surface of the suspension; and applying energy to the solder material to melt the solder material and cause it to move toward and contact the upper surface of the suspension.

These and various other features and advantages will be apparent from a reading of the following detailed description.

### BRIEF DESCRIPTION OF THE DRAWINGS

The present invention will be further explained with reference to the appended Figures, wherein like structure is referred to by like numerals throughout the several views, and wherein:

FIG. 1 is a perspective view of a prior art configuration of a portion of a slider positioned relative to a portion of a suspension arm;

FIG. 2 is a schematic side view of a prior art solder joint connection of FIG. 1 between a portion of the slider and a portion of the suspension arm;

FIG. 3 is a perspective view of an embodiment of an electrical connection configuration between a portion of a slider and a portion of a suspension arm;

FIG. 4 is a schematic side view of the embodiment of a portion of a slider and a portion of a suspension arm of FIG. 3;

FIG. 5 is a schematic side view of a solder layer extending from a portion of a suspension arm that is positioned relative to an adjacent slider;

FIG. 6 is a schematic side view of the solder layer of FIG. 5 being reformed with applied heat to move toward the adjacent slider;

FIG. 7 is a schematic side view of the solder layer of FIG. 6 being reformed with applied heat to contact the adjacent slider;

FIG. 8 is a schematic side view of the solder layer and suspension arm similar to FIG. 5, but with the addition of at least one non-wettable portion on the suspension;

FIG. 9 is a schematic side view of a solder layer extending from a portion of a suspension arm that is positioned relative to an adjacent slider;

FIG. 10 is a schematic side view of the solder layer of FIG. 9 being reformed with applied heat to move toward the adjacent slider; and

FIG. 11 is a schematic side view of the solder layer of FIG. 10 being reformed with applied heat to contact the adjacent slider.

### DETAILED DESCRIPTION

The methods and features described herein are applicable to an area where there is an operative connection between a slider and a head suspension assembly. This area typically includes the provision of a gimbal or flexure element for permitting the slider to move at least along pitch and roll axes relative to the presentation of the slider to a spinning disk The gimbal or flexure can be created integrally with the head suspension assembly or as a separate component and attached to the head suspension assembly. In either case, the gimbal or flexure includes a slider bond pad to which the slider is attached for controlled movement of the slider as it flies over the media surface of a spinning disk. Such a head slider typically includes a series of bond pads in a row over a portion of its edge.

The bond pads described herein are provided for electrical connection to the many transducer devices and other devices of a developed slider design, including contacts for read and write transducers, read and write heaters, and/or laser elements as may be provided for operation of a head slider. Certain functional elements of such a slider require positive and negative bond pads for electrical operation, while others require a single bond pad for electrical operation. These bond pads are conventionally electrically connected with wires or conductor elements that are typically provided to extend along the supporting head suspension assembly for controlled operation of each of the functional elements of the head slider.

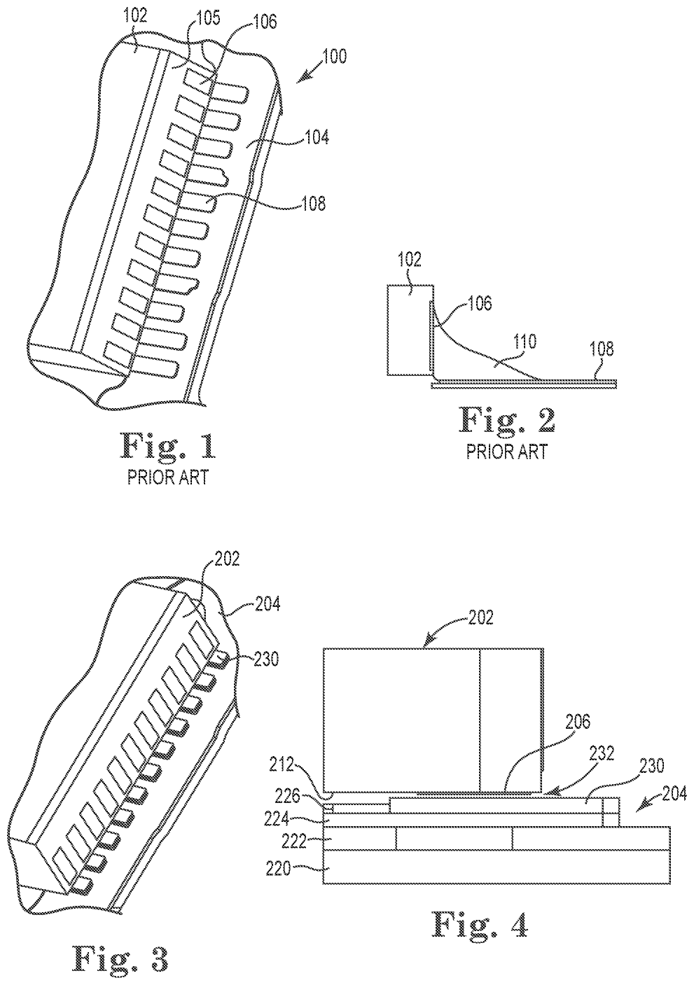

Referring now to the Figures, wherein the components are labeled with like numerals throughout the several Figures, and initially to FIGS. 1 and 2, a portion of a typical head gimbal assembly (HGA) electrical interconnect 100 is illustrated. This interconnect 100 is formed between a slider 102 and a suspension flex circuit 104 with a solder connection 110. To form the interconnect, slider 102 having a leading edge 105 with multiple slider bond pads 106 is placed on suspension flex circuit 104 such that slider bond pads 106 are adjacent to and generally perpendicular to suspension bond pads 108 of the suspension. A number of different types of methods and devices can then be used to jet solder material to connect the slider bond pads 106 to the suspension bond pads 108 in a thermal interconnect process. Such solder jetting can have at least some inherent trajectory error and possible solder ball deformation upon impact with a surface to which it is applied, thereby leading to possible issues in high density applications.

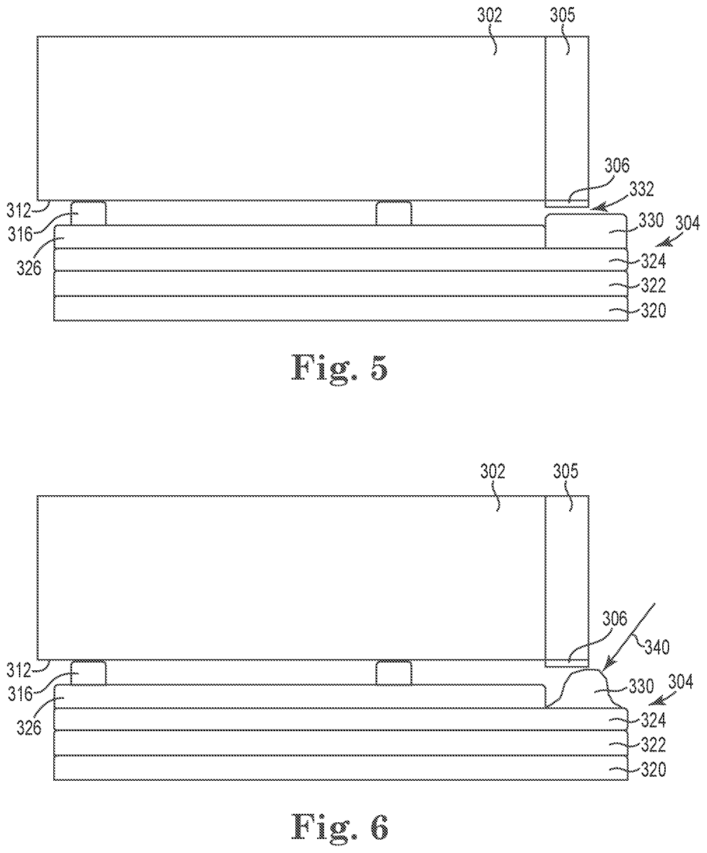

FIGS. 3 and 4 illustrate an embodiment of the present invention, which is a configuration for electrically connecting slider bond pads and suspension bond pads that overcomes disadvantages of present connection methods and devices. In particular, a slider 202 is illustrated adjacent to a portion of a suspension 204, wherein a bottom surface 212 of the slider 202 is generally parallel to an uppermost surface of the suspension 204. In more particularity, the illustrated portion of suspension 204 includes a number of layers, including a base layer 220, an insulating layer 222, a trace layer 224, and one or more covercoat layers 226, wherein the uppermost surface of this multi-layer configuration may be parallel or generally parallel to the bottom surface 212 of the slider. It is understood that the number of layers, the relative thicknesses of the layers, and composition of these layers can vary to meet various manufacturing and performance specifications; however, one exemplary embodiment includes base layer 220 made of stainless steel, insulating layer 222 made of polyimide, trace layer 224 that includes multiple traces, and covercoat layer(s) 226 made of a high-temperature plastic material used as a protective layer.

The configuration illustrated in FIGS. 3 and 4 further includes a pre-deposited solder layer 230 positioned on top of an end portion of the trace layer 224. A slider bond pad 206 is also provided on the bottom surface 212 of the slider 202. The slider 202 is positioned above the suspension so that a slight gap 232 is provided between the solder layer 230 and the slider bond pad 206, which will be discussed in further detail below.

In embodiments of the invention, the solder layer may be made of any suitable solder material or combination of solder materials, such as SnPb (tin-lead) or lead-free solder, such as SnCu (tin-copper), SAC (tin-silver-copper), SnBi (tin-bismuth), ZnAl (zinc-aluminum), In (indium) and Sn (tin), for example. Flux may or may not be present within or on top of the solder material.

Additionally referring to FIGS. 5-7, an embodiment of providing an electrical interconnect is illustrated in sequential order of an exemplary solder connection process. Similar to the embodiment described above, a slider 302 is illustrated adjacent to a portion of a suspension 304, wherein a bottom surface 312 of the slider 302 is generally parallel to a top surface of the suspension 304. Slider 302 includes an end portion 305 that may be an alumina layer or portion, for example. The illustrated portion of suspension 304 includes a number of layers, such as a base layer 320, an insulating layer 322, a trace layer 324, and one or more covercoat layers 326, wherein the uppermost surface of this multi-layer configuration may be parallel or generally parallel to the bottom surface 312 of the slider. It is understood that the number of layers and the relative thickness of these layers can vary from the illustration.

The suspension 304 further includes multiple stand-offs 316 that may be deposited on top of the suspension 304 to provide a desired spacing between surfaces at defined locations across the suspension. The stand-offs 316 may be made of the same material as the covercoat layer(s) 326 or a may be made of a different material. It is also contemplated that stand-offs may be provided on the bottom of the slider instead of or in addition to stand-offs on the top of the suspension, or that desired spacing between the slider and suspension may be achieved in some other manner.

The configuration illustrated in FIG. 5 further includes a pre-deposited solder layer 330 positioned on top of a portion of the trace layer 324. The term “pre-deposited” refers to the specific and controlled placement of the solder layer on a layer of the suspension so that solder does not “splat” when jetted onto that surface, for example. A slider bond pad 306 is provided on the bottom surface 312 of the slider 302 in the area of the end portion 305. The slider 302 is positioned so that a slight gap 332 is provided between the solder layer 330 and the slider bond pad 306. The solder layer 330 is configured to have a height, width, and depth that will provide for a sufficient bond in further processing of the slider.

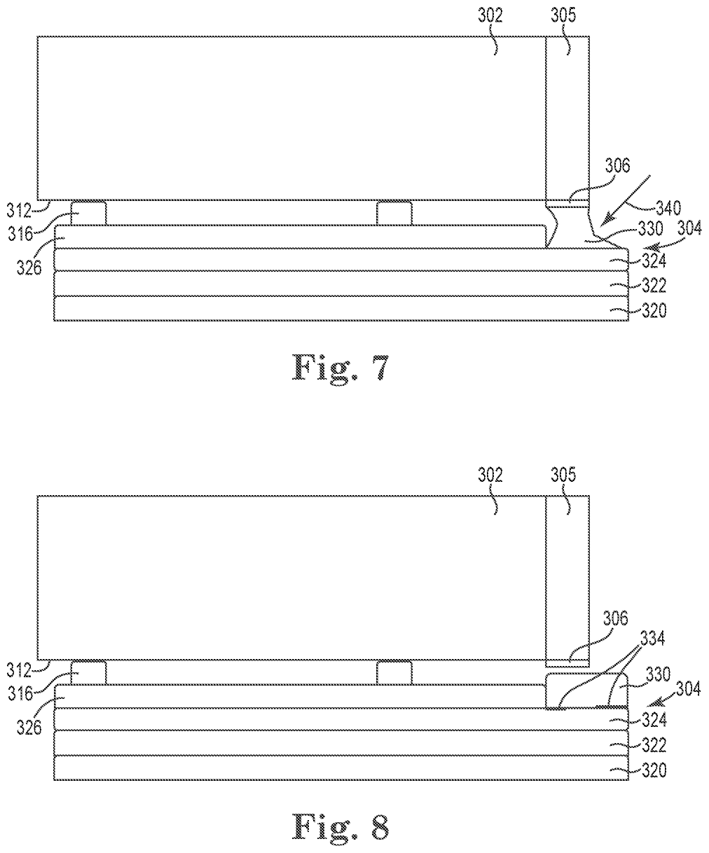

FIG. 6 illustrates the configuration of FIG. 5 with the application of laser radiation (illustrated as arrow 340) to the solder layer 330. A sufficient intensity and duration of laser radiation will be applied until the solder melts and surface tension causes the solder material to “ball up,” thereby reducing the distance between the solder material 330 and the slider bond pad 306. The laser radiation may continue to be applied as the solder material 330 deforms enough to contact the slider bond pad, as is illustrated in FIG. 7, thereby providing an electrical connection between the slider 302 and the suspension 304. That is, surface tension of the liquid solder will bridge the gap between the surfaces and allow for bonding of the components.

In an example of a method used in accordance with the description provided herein, the solder material 330 is heated to greater than 300 degrees C. while contacting a wettable layer of the slider bond pad 306 to drive the solder wetting without flux. It is noted that a sufficient amount of solder material is provided in the solder layer to allow for desired contact with the slider bond pad after deformation, but not so much material that it can expand beyond desired expansion limits (e.g., onto adjoining components).

FIG. 8 is an another configuration of the embodiment of FIGS. 5-7, and with the addition of a non-wettable layer 334 on one or more portions of the trace layer 324. The illustrated positions of the non-wettable layer 334 are only intended to be exemplary locations, and it is understood that the non-wettable layer can be positioned under and/or adjacent to the slider. Such a configuration can provide for a greater increase in the height of the solder material 330 during the solder melting process. One example of material that can be used for layer 334 is titanium.

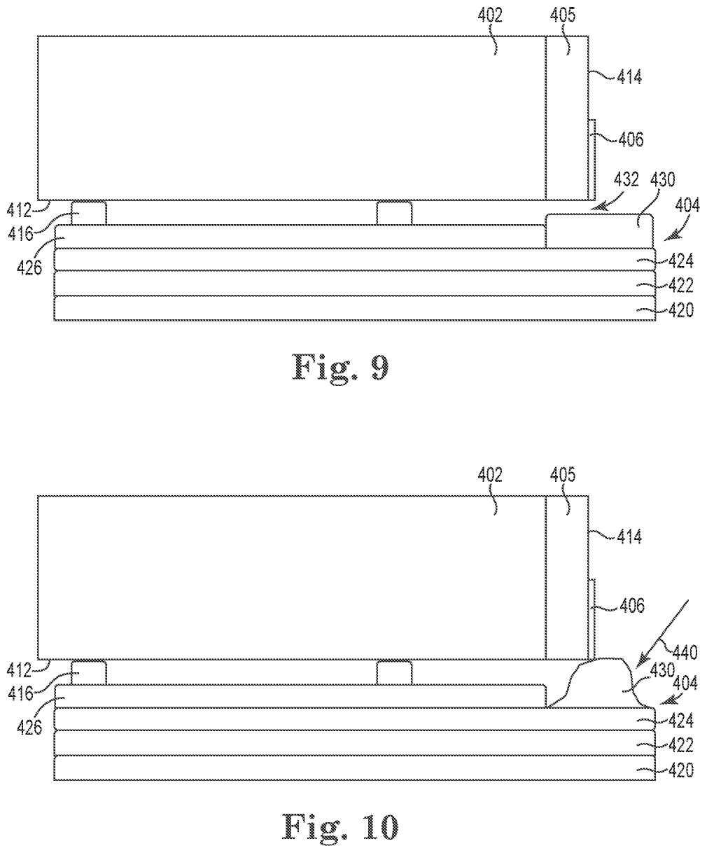

Referring now to FIGS. 9-11, an embodiment of providing an electrical interconnect is illustrated in sequential order of an exemplary solder connection process. Similar to the embodiment described above, a slider 402 is illustrated adjacent to a portion of a suspension 404, wherein a bottom surface 412 of the slider 402 is generally parallel to an upper surface of the suspension 404. Slider 402 includes an end portion 405 that may be an alumina layer or portion, for example. The illustrated portion of suspension 404 includes a number of layers, such as a base layer 420, an insulating layer 422, a trace layer 424, and one or more covercoat layers 426, wherein the uppermost surface of this multi-layer configuration may be parallel or generally parallel to the bottom surface 412 of the slider. It is understood that the number of layers and the relative thickness of these layers can vary from the illustration.

The suspension 404 further includes multiple stand-offs 416 that may be deposited on top of the suspension 404 to provide a desired spacing between surfaces at defined locations across the suspension. The stand-offs 416 may be made of the same material as the covercoat layer(s) 406 or a may be made of a different material. It is also contemplated that stand-offs may be provide on the bottom of the slider instead of or in addition to stand-offs on the top of the suspension, or that desired spacing between the slider and suspension may be achieved in some other manner.

The configuration illustrated in FIG. 9 further includes a pre-deposited solder layer 430 positioned on top of a portion of the trace layer 424. A slider bond pad 406 is provided on a front surface 414 of end portion 405. In this configuration, the slider bond pad 406 is generally perpendicular to the bottom surface 412 of the slider, although it can instead be positioned at a different angle relative to the bottom surface 412 of the slider. The slider 402 is positioned so that a slight gap 432 is provided between the solder layer 430 and the bottom surface 412 of the slider. The solder layer 430 is configured to have a height, width, and depth that will provide for a sufficient bond in further processing of the slider.

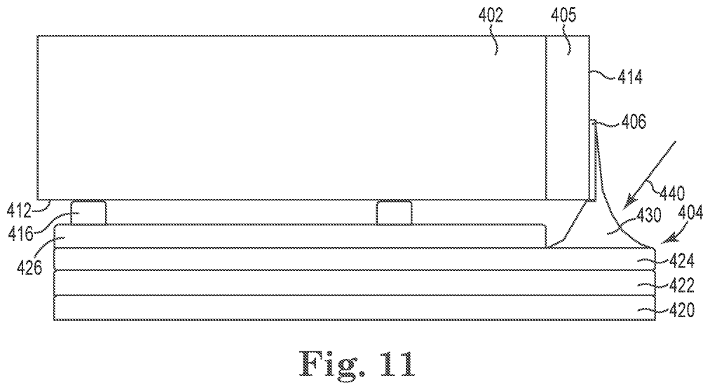

FIG. 10 illustrates the configuration of FIG. 9 with the application of laser radiation (illustrated as arrow 440) to the solder layer 430. A sufficient intensity and duration of laser radiation will be applied until the solder melts and surface tension causes the solder material to “ball up”, thereby reducing the distance between the solder material 430 and the bottom surface 412 of the slider. At this point, the solder is also approaching a bottom edge of the slider bond pad 406. The laser radiation may continue to be applied as the solder material 430 deforms enough to contact and wet to the slider bond pad 406, as is illustrated in FIG. 11, thereby providing an electrical connection between the slider 402 and the suspension 404. That is, surface tension of the liquid solder will bridge the gap between the surfaces and allow for bonding of the components.

While the above description refers to the application of electromagnetic radiation generated by a laser to cause the desired deformation of the solder material, it is contemplated that other methods of heating the solder material can be used. For example, the portion of the assembly that includes the solder material can be heated in an oven or subjected to hot gas or energy that is delivered by jetting a small amount of solder or a non-laser source of electromagnetic radiation. Such heat can be provided instead of or in addition to the application of laser radiation.

In another embodiment, the solder material is provided on the slider bond pad instead of the trace layer. With this embodiment, the electrical connection process will include heating of the solder material until it expands sufficiently toward the trace layer until contact is made for a desired connect of the slider bond pad to the suspension. In yet another embodiment, solder material is provided on both the slider bond pad and the trace layer. With this embodiment, the electrical connection process will include heating of the solder materials until both expand sufficiently to contact each other and provide a desired connection of the slider bond pad to the suspension.

One additional advantage of the above-described embodiments that include a gap between the solder and an opposed bonding pad is that the solder interconnects can be made either individually or simultaneously. Other designs with solder between the slider and suspension often require all solder pads to be liquid at the same time in order to achieve the desired spacing between the slider and suspension. Since the slider height of this design is already fixed, solder interconnects can be made one at a time without impacting slider-to-suspension spacing.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

What is claimed is:

1. A method of interconnecting multiple components of an electrical assembly with a solder joint, comprising the steps of:
positioning a suspension adjacent to a slider to provide a connection area between the suspension and the slider, wherein the suspension comprises a pre-deposited quantity of solder material with a height that provides for a predefined gap between a lower surface of the slider and an upper surface of the solder material; and
applying energy to the solder material to melt the solder material and allow it to move toward and contact the lower surface of the slider.

2. The method of claim 1, further comprising a step of providing additional energy to the solder during its contact with the lower surface of the slider to create a solder joint between the suspension and the slider.

3. The method of claim 2, wherein the lower surface of the slider comprises a slider bond pad such that the solder joint is formed between the suspension and the slider bond pad.

4. The method of claim 1, wherein the lower surface of the slider and an upper surface of the suspension are generally parallel.

5. The method of claim 1, wherein the predefined gap is provided by stand-offs at the interface between the slider and the suspension.

6. The method of claim 1, wherein the step of applying energy comprises applying laser radiation to the solder material.

7. The method of claim 1, wherein the pre-deposited quantity of solder material is positioned on an upper surface of the suspension.

8. The method of claim 7, wherein the upper surface of the suspension comprises a trace material.

9. The method of claim 7, wherein the upper surface of the suspension further comprises a non-wettable portion positioned at least one of under and adjacent to the slider.

10. The method of claim 2, wherein a front surface of the slider that is generally perpendicular to the lower surface of the slider comprises a slider bond pad such that the solder joint is formed between the suspension and the slider bond pad.

11. The method of claim 1, wherein the lower surface of the slider comprises a pre-deposited quantity of slider solder material, and wherein the method further comprises a step of applying energy to the slider solder material to melt the slider solder material and allow it to move toward and contact the solder material of the suspension.

12. A method of interconnecting multiple components of an electrical assembly with a solder joint, comprising the steps of:
positioning a suspension adjacent to a slider to provide a connection area between the suspension and the slider, wherein a lower surface of the slider comprises a pre-deposited quantity of solder material with a height that provides for a predefined gap between a lower surface of the solder material and an upper surface of the suspension; and
applying energy to the solder material to melt the solder material and cause it to move toward and contact the upper surface of the suspension.

13. The method of claim 12, further comprising a step of continuing to heat the solder during its contact with the upper surface of the suspension to create a solder joint between the suspension and the slider.

14. The method of claim 12, wherein the lower surface of the slider and an upper surface of the suspension are generally parallel.

15. The method of claim 12, wherein the predefined gap is provided by stand-offs at the interface between the slider and the suspension.

16. The method of claim 12, wherein the step of applying energy comprises applying laser radiation to the solder material.

17. The method of claim 12, wherein the lower surface of the slider further comprises a non-wettable portion positioned at least one of under and adjacent to the slider.
